(19) United States
(12) Patent Application Publication
(10) Pub. No.: US 2010/0214805 A1
(43) Pub. Date: Aug. 26, 2010

(54) Optical film, manufacturing process thereof and applied back light module

(76) Inventors: Wen-Feng Cheng, Taoyuan County (TW); Chen-Sheng Lee, Taoyuan County (TW)

Correspondence Address: Jackson Intellectual Property Group PLLC, 106 Starvale Lane, Shipman, VA, 22971, US

(21) Appl. No.: 11/892,995

(22) Filed: Aug. 29, 2007

(51) Int. Cl. F21V 7/04; B05D 5/06

(52) U.S. Cl. 362/627; 427/162

(57) ABSTRACT

An optical film capable of delivering high level of brightness including a surface of an incident plane of the optical film constructed with multiple light penetration areas segregated by multiple reflection microstructures each provided with a groove; each groove is covered up with a reflective material; and when the optical film is applied in a backlight module, all streams of light entering into the optical film are effectively centered on those light penetration areas constructed on the optical film for further irradiation out of the optical film.

### BACKGROUND OF THE INVENTION

(a) Field of the Invention

The present invention is related to a structure of an optical film and a manufacturing process thereof, and more particularly, to an optical film delivering high brightness level.

(b) Description of the Prior Art

Direct or side edge type backlight module configuration may be selected for an LCD generally applied in an information device depending on practical design requirements. FIG. 1 of the accompanying drawings shows a sectional view of a conventional direct type backlight module structure generally applied in the LCD. As illustrated, a backlight module 40 is comprised of a back plate 41, multiple light sources 42, a diffuser 43, and a display panel 44 in sequence from the inside to the outside. Wherein, each light source 42 is related to a lamp in straight, U-shaped or snaked form and multiple lamps are arranged in proper spacing at where between the back plate 41 and the diffuser 43 and fixed to the back plate 41; and stream of lights emitted from each and all light sources constitutes display effects of liquid crystal module.

To increase brightness of the entire backlight module 40, multiple, and two as illustrated, diffusion films 47, one or a plurality of brightness enhancement film (BEF) 45, and a dual brightness enhancement Film (DBEF) 46 are usually disposed at where between the diffuser 43 and the display panel 44. Wherein, those diffusion films while helping diffusion by the diffuser get more consistent upgrades luminance of the entire backlight module. However, sources of those brightness enhancement films 45 are practically controlled by 3M. The profit is considerably thin for the display industry in Taiwan though enjoying prosperous development because that supplies of key components of the display industry remain monopolized by foreign companies for years. Furthermore, more optical films used for the configuration of the backlight module means compromised optical efficiency, limited yield of assembly, and increased thickness of the backlight module.

### SUMMARY OF THE INVENTION

The primary purpose of the present invention is to provide an optical film delivering high level of brightness. To achieve the purpose, multiple light penetration areas segregated by multiple reflection microstructures are constructed on surface of an incident plane of the optical film. Wherein, each reflection microstructure is provided with a groove and each groove is covered up with a reflective material.

Accordingly, incident lights at greater angle emitted form those light sources are reflected and blocked by those reflection microstructures to permit only those incident lights at smaller angles to enter into the optical film through areas other than that of those reflection microstructures. Whereas only those incident lights at smaller angles are permitted to pass through the optical film while those at greater angles are reflected for reuse, streams of light are capable of centering at a comparatively narrower angle of view thus to increase the brightness of the optical film.

Substantially, the present invention provides the following efficacies:

1. The optical film of the present invention can be applied in a backlight module for the backlight module to achieve performance of high level of brightness.

2. The optical film of the present invention for delivering feature of high brightness is capable of replacing brightness enhancement film and reducing the use of diffusion film, thus to effectively reduce the thickness of the backlight module.

### BRIEF DESCRIPTION OF THE DRAWINGS

FIG. 1 is a schematic view showing a construction of a conventional direct type backlight module.

FIG. 2(A) and FIG. 2(B) are two perspective views of a first preferred embodiment of the present invention.

FIG. 3 is a process flow path showing a manufacturing process of an optical film of the present invention.

FIG. 4(A) and FIG. 4(B) are two sectional views respectively showing a surface of the optical film of the present invention is covered up with a mask pattern plate.

FIG. 5 is a schematic view showing a function of multiple reflection microstructures disposed in the present invention.

FIG. 6 is a magnified view of a local section of an optical film of a second preferred embodiment of the present invention.

FIG. 7 is a schematic view showing streams of light penetrating through the entire optical film of the present invention.

FIG. 8 is a magnified view of a local section of an optical film of a third preferred embodiment of the present invention.

FIG. 9 is a magnified view of a local section of an optical film of a fourth preferred embodiment of the present invention.

FIG. 10 is a schematic view showing a construction of the optical film of the present invention applied in a direct type backlight module.

FIG. 11 is a schematic view showing a construction of the optical film of the present invention applied in a side-edge type backlight module.

FIG. 12(A) is a schematic view showing that streams of light from deeper grooves pass through the optical film of the present invention.

FIG. 12(B) is a schematic view showing that streams of light from shallower grooves pass through the optical film of the present invention.

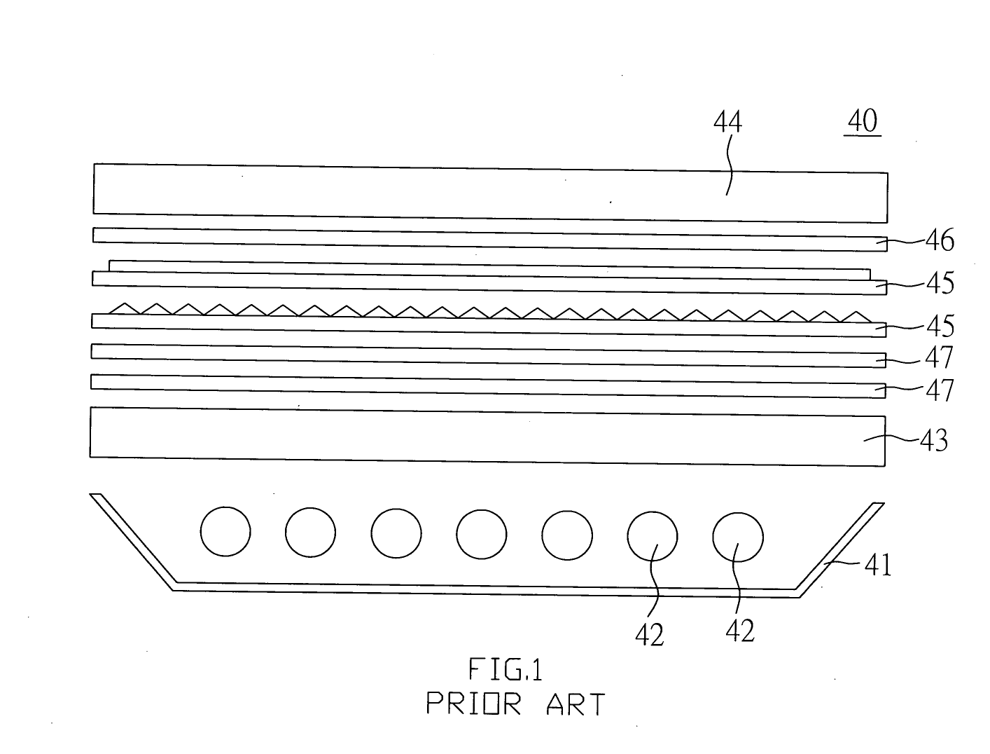

### DETAILED DESCRIPTION OF THE PREFERRED EMBODIMENTS

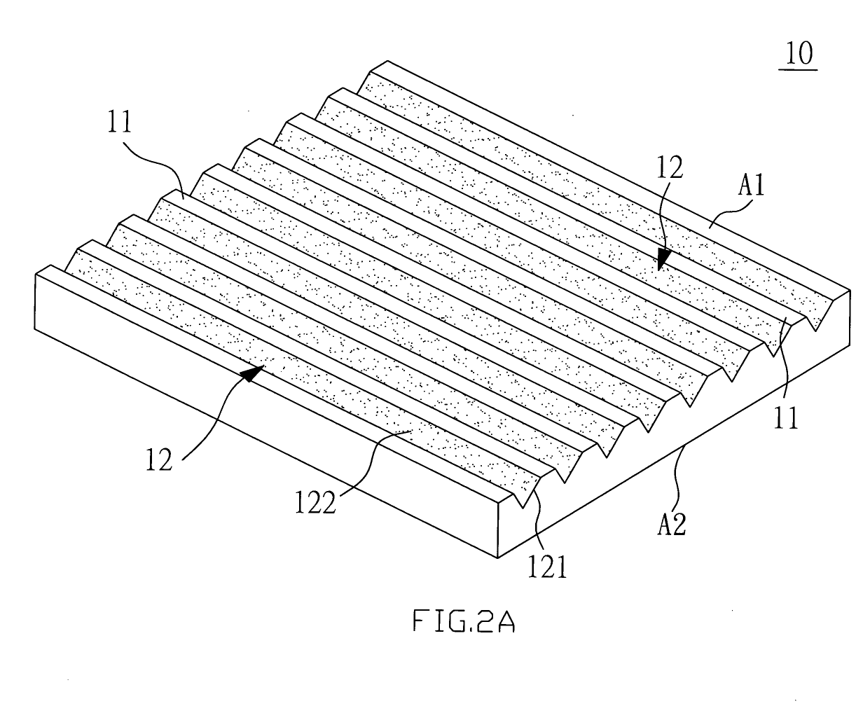

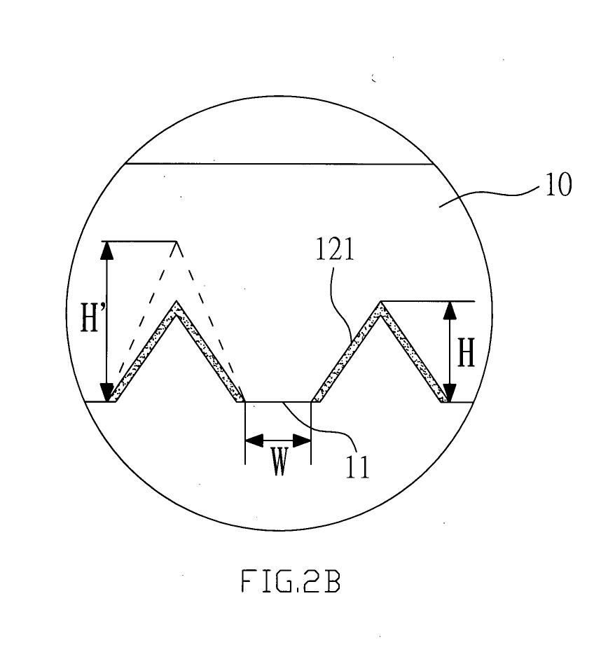

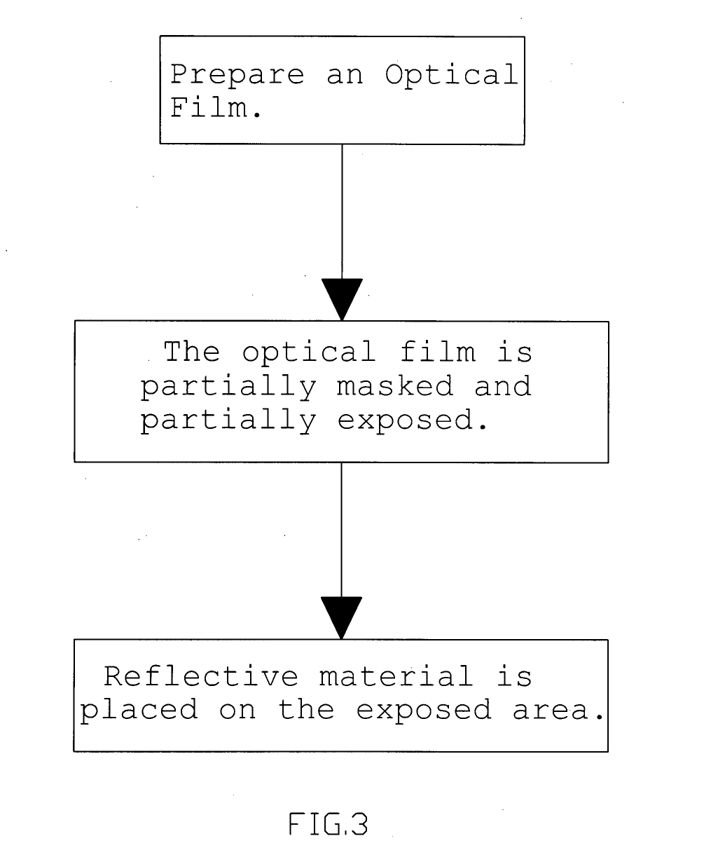

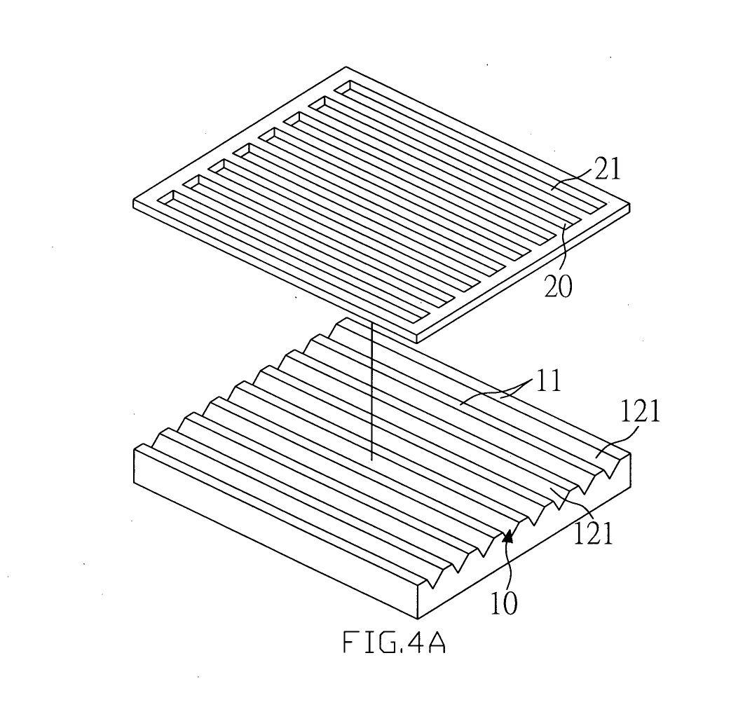

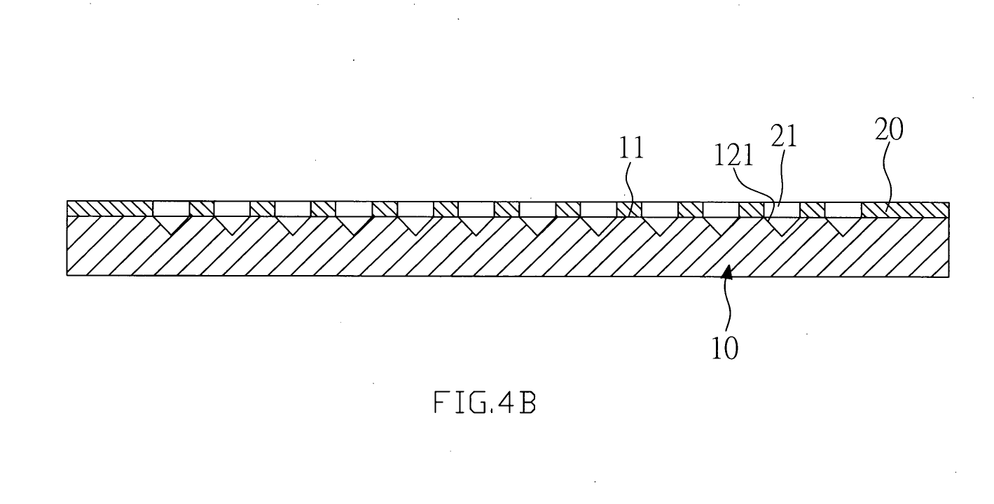

The purpose of the present invention is to provide an optical film delivering high level of brightness and a reflection microstructure used by the optical film. Referring to FIG. 2(A), an optical film 10 is provided with an incident plane A1 and an irradiation plane A2 and multiple light penetration areas 11 segregated by multiple reflection microstructures 12 are constructed on a surface of the incident plane A1; wherein each reflection microstructure 12 is disposed with a V-shaped groove 121 on the surface of the incident plane A1 of the optical film 10, and each V-shaped groove 121 is covered up by a reflective material 122. Should a width of the light penetration area be designated as “w” as illustrated in FIG. 2(B); a depth of the V-shaped groove penetrating into the optimal film 10 be designated as “H” or “H′”, the numeric value of the “H” or “H′” greater than that of the “w”. Of course, the groove may be related to a U-shaped groove. The reflective material 122 may be related to a metal or alloy coating, e.g., Ag, Al, Al₂O₃, TiO₂ or SiO₂. As illustrated in FIGS. 3, 4(A), and 4(B), a manufacturing process of the optical film of the present invention involves a preparation of an optical film 10; multiple V-shaped grooves 121 being formed on a surface of the optical film 10; a partial area of the optical film is masked while leaving remaining area exposed by using a masking pattern plate 20 to cover upon the surface of the optical film 10 with the masking pattern plate 20 disposed with multiple windows 21 to be abutted to their corresponding V-shaped grooves 121, so that there are only those areas where V-shaped grooves 121 exposed are exposed out of the surface of the optical film 10 and the remaining areas on the surface of the optical film 10 are masked; then the reflective material is applied to the exposed areas to effectively control those reflective materials in the position of each V-shaped groove in the subsequent coating operation of reflective material.

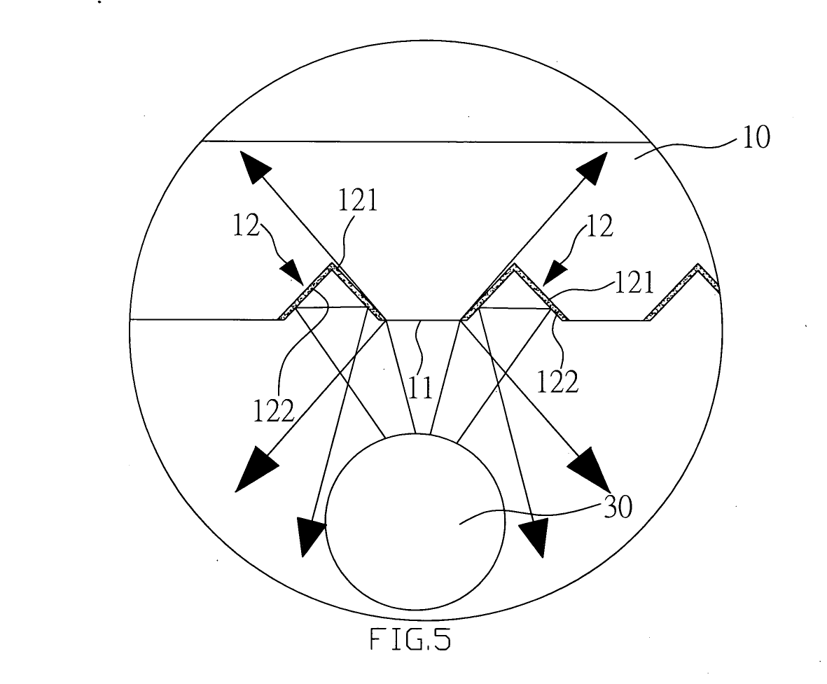

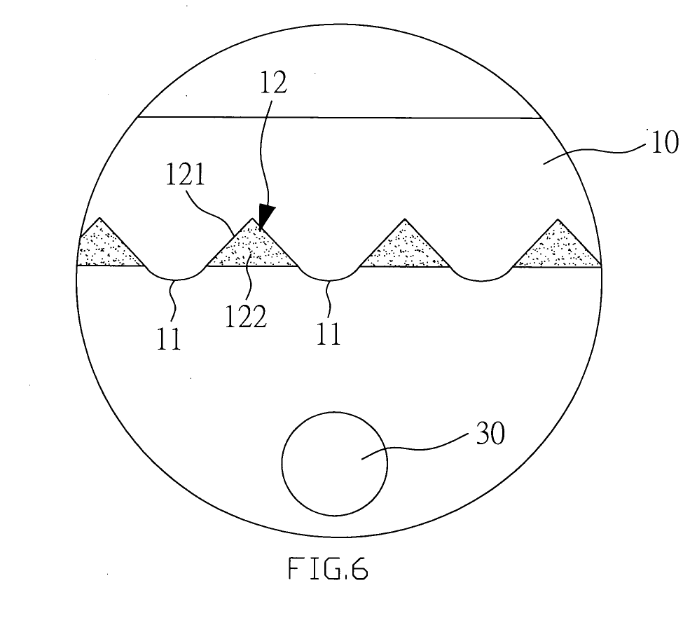

The reflective material of the reflection microstructure 12 covers upon on a surface of each V-shaped groove as illustrated in FIG. 5 or fills up each V-shaped groove 121 as illustrated in FIG. 6. In either process, a primary purpose is to allow a position where covered or filled up with the reflective material 122 to be capable of reflecting light.

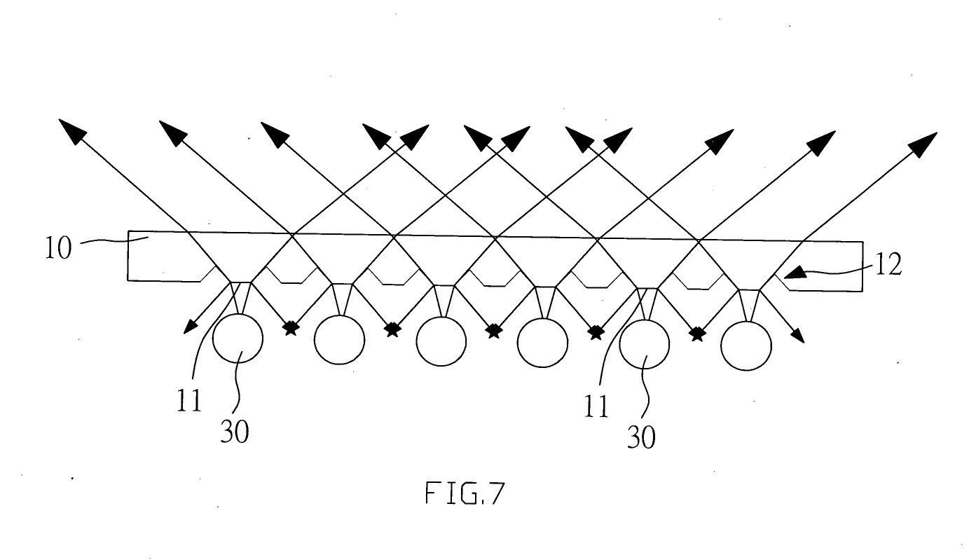

As illustrated in FIGS. 5 and 7, when subject to those reflection microstructures 12, incident lights of greater angles emitted from those light sources 30 are reflected and blocked by the reflection microstructures 12 to permit only those incident lights emitted from those light sources to pass through areas other than those reflection microstructures to enter into the optical film 10; a block area defined between two V-shaped grooves 121 of each reflection microstructure 12 serves a light guide route for the incident lights so to have all streams of light emitted form those light sources 30 that that enter into the optical film 10 to effectively center on an light penetration area 11 constructed in the optical film for irradiation out of the optical film 10. Whereas only those incident lights at smaller angles are allowed to penetrate through the optimal film 10 while most of those incident lights at larger angles are reflected for reuse, streams of light are then concentrating on a comparatively narrower angle of view to promote brightness.

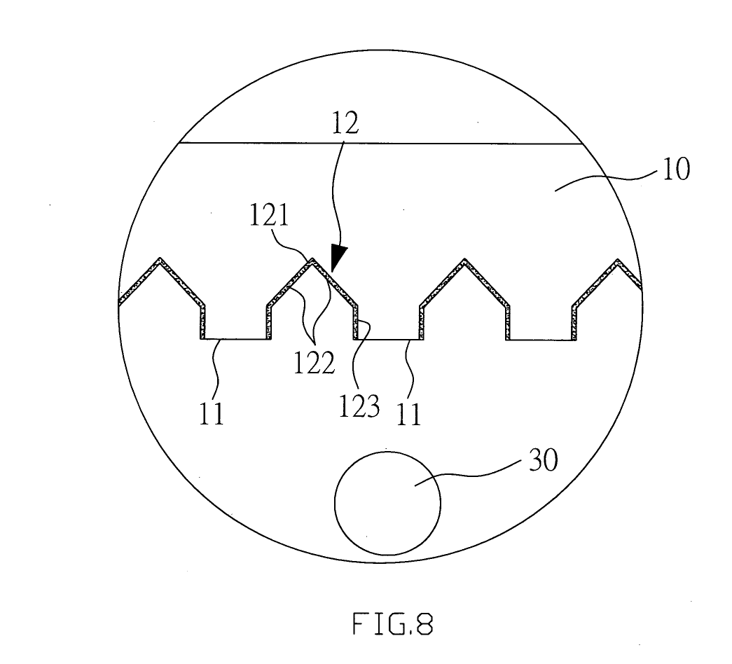

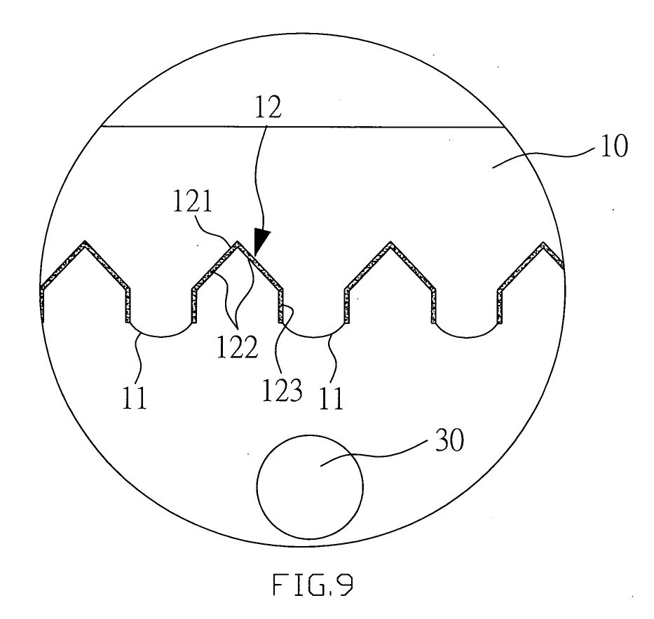

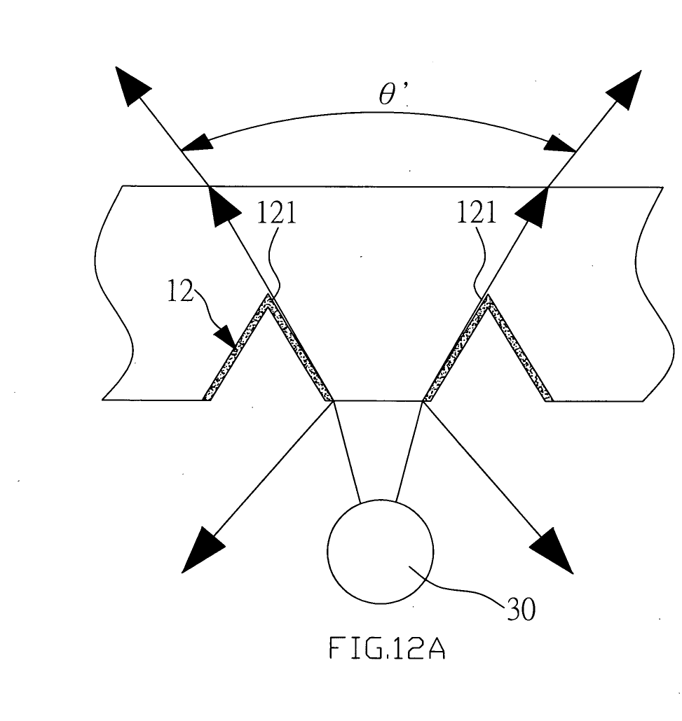

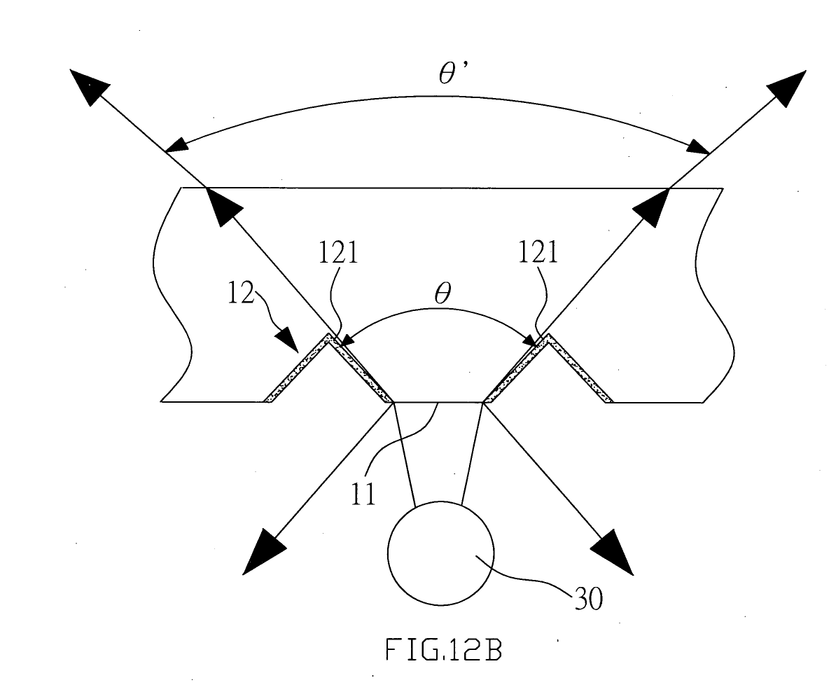

Furthermore, an incident plane on the light penetration area 11 of the optical film 10 may be made in a flat plane as illustrated in FIGS. 5 and 7 or a convex as illustrated in FIG. 6. The convex light penetration area 11 for giving light condensation effects further increase the brightness of the optical film. Whether the incident plane of the light penetration area is made flat or convex, the depth of the V-shaped groove in the reflection microstructure 12 may be adjusted depending on a view angle to be centered for the light as illustrated in FIGS. 8 and 9. For example, if the view angle θ′ to be centered is comparatively narrower, a deeper V-shaped groove 121 may be provided as illustrated in FIG. 12(A); and a wider θ′, a shallower V-shaped groove 121, as illustrated in FIG. 12(B). To control a range of the view angle θ′, an expansion angle θ defined by two abutted V-shaped grooves 121 in the light penetration area 11 is set at a range between 10˜60°. Furthermore, a vertical extension wall 123 in a given height is provided between the V-shaped groove 121 and the surface of the optical film 10 as illustrated in FIG. 9 to control a functional range of the light guide route for all streams of light from those light sources entering into the optical film 10 to effectively concentrate on the light penetration area 11 constructed on the optical film to further emit out of the optical film.

As applicable, the V-shaped groove may be filled up with the reflective material 122 or both of the V-shaped groove and the vertical extension wall are filled up with the reflective material 122; or the reflective material 122 covers up the V-shaped groove and the vertical extension wall as illustrated in FIGS. 8 and 9.

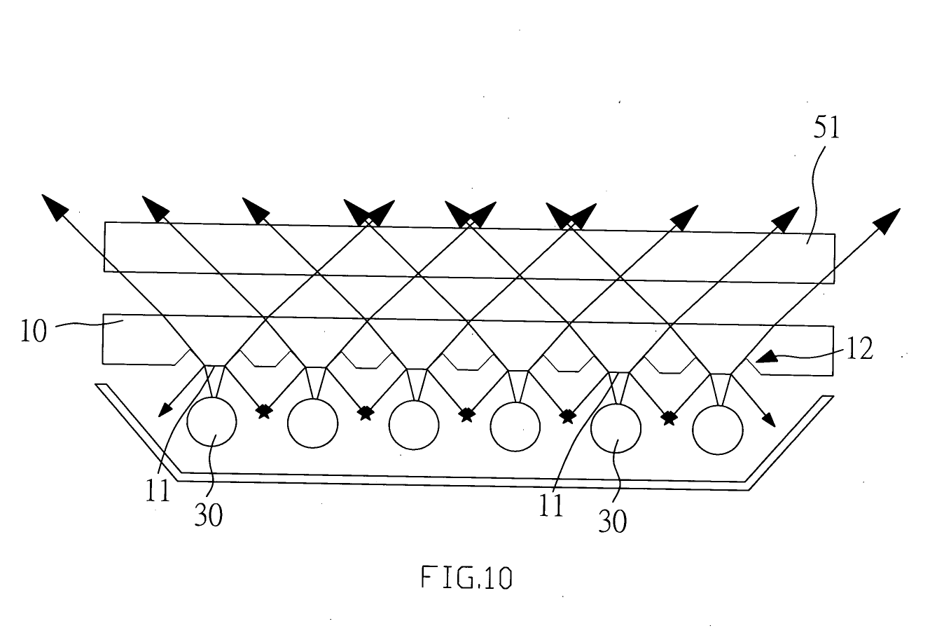

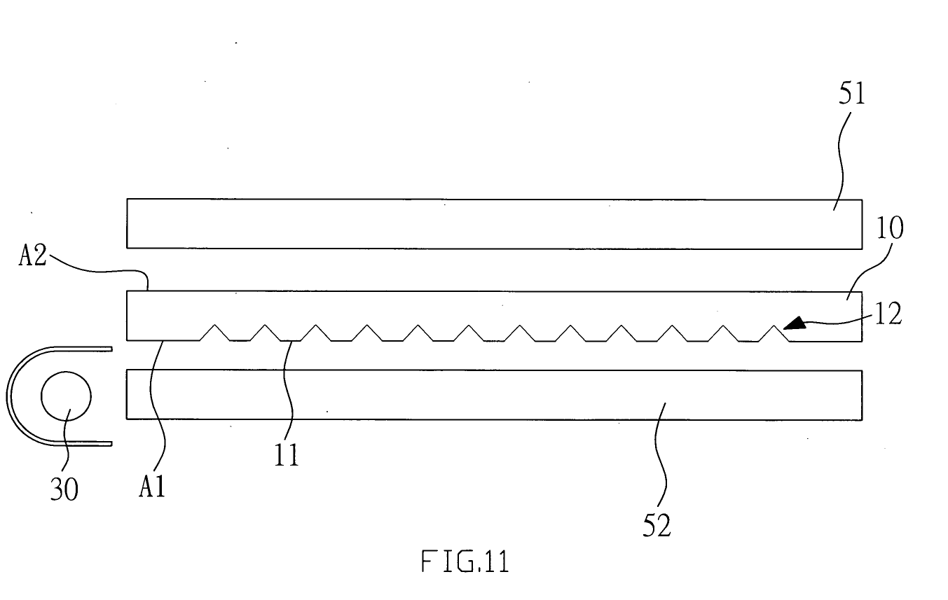

The optical film constructed with those multiple reflection microstructures can be applied in a backlight module as illustrated in FIG. 10, wherein an optical film of the present invention is applied in a direct type backlight module. As illustrated, the optical film 10 is placed above multiple light sources 30; a display panel 51 is disposed on top of the optical film 10; and each light source 30 is disposed at where right beneath each light penetration area 11. As illustrated in FIG. 11, an optical film of the present invention is applied in a side-edge type of backlight module. Wherein, the side-edge type backlight module is comprised of the display panel 51, the optical film 10, a light guide plate 52, and multiple light sources 30. A surface of the incident plane of the optical film 10 is also constructed with multiple light penetration areas 11 segregated by multiple reflection microstructures 12; the light guide plate 52 is placed at where below the optical film 10 and in opposite to a side of the incident plane A1 of the optical film 10; the display panel 51 is disposed on top of the optical film 10 in opposite to a side of the irradiation plane A2 of the optical film 10; and each light source 30 has incident light on a side of the light guide plate 52. Accordingly, light emitted form the light source irradiates from where above the light guide plate 52 before becoming incident light on the incident plane A1 of the optical film 10 and those streams of light further travel up to enter into the display panel 51 for achieving purpose of display.

Whether the optical film 10 is applied in a direct or side-edge backlight module, those spaced multiple reflection microstructures and light penetration areas disposed on the incident plane of the optical film reflect and block lights at greater angles emitted from those light sources to permit only those lights at smaller angles to enter into the optical film through areas (i.e., those light penetration areas) other than those occupied by reflection microstructures. Whereas only lights at smaller angles are permitted to penetrate through the optical film while incident lights at greater angles are reflected for reuse, streams of light are able to center on a comparatively narrower angle of view to promote brightness in turn.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. An optical film comprising
an irradiation plane;
an incident plane disposed with multiple light penetration areas; and
multiple reflection microstructures each provided with a groove on the incident plane and disposed with a reflective material.

2. The optical film as claimed in claim 1, wherein the incident plane of the light penetration area is related to a flat or a convex.

3. The optical film as claimed in claim 1, wherein a vertical extension wall in a given height is disposed between each groove and the incident plane of the optical film.

4. The optical film as claimed in claim 1, wherein the groove is covered up or filled up with the reflective material.

5. The optical film as claimed in claim 1, wherein a vertical extension wall in a given height is disposed between each groove and the incident plane of the optical film; and the groove and a surface of the vertical extension wall are filled up with the reflective material.

6. The optical film as claimed in claim 1, wherein a vertical extension wall in a given height is disposed between each groove and the incident plane of the optical film; and the groove and a surface of the vertical extension wall are covered up with the reflective material.

7. The optical film as claimed in claim 1, wherein the groove is related to a V-shaped or U-shaped groove.

8. The optical film as claimed in claim 1, wherein the reflective material is related to Ag, Aluminum, Al₂O₃, TiO₂, or SiO₂ or alloy coating.

9. The optical film as claimed in claim 1, wherein a depth of the groove penetrating into the optical film is greater than a width of the light penetration area.

10. The optical film as claimed in claim 1, wherein an expansion angle defined by two abutted groves in the light penetration area falls between 10˜60°.

11. The optical film as claimed in claim 1, wherein multiple light sources are disposed at where below the optical film.

12. The optical film as claimed in claim 1, wherein one side of the incident plane of the optical film is disposed with a light guide plate and incident light is irradiated from multiple light sources disposed on side edge of the light guide plate.

13. A manufacturing process for an optical film comprising the following steps:
an optical film is prepared;
a partial area of the optical film is masked to leave other areas exposed; and the masked area and the exposed area are arranged with a certain spacing; and
a reflective material is disposed on the exposed area for a surface of the optical film to form multiple light penetration areas segregated by multiple reflection areas.

14. The optical film manufacturing process as claimed in claim 13, wherein the surface of the optical film is covered up with a mask pattern plate; and the mask pattern plate is disposed with multiple windows with a certain spacing to further expose each exposed area out of the window.

15. The optical film manufacturing process as claimed in claim 13, wherein multiple grooves are first formed on the surface of the optical film before covering up the surface of the optical film with a masking pattern plate; the masking plate is disposed with multiple windows to be abutted to its corresponding groove for the groove to form an exposed area through each window.
